(19) United States
(12) Patent Application Publication
(10) Pub. No.: US 2013/0346338 A1
(43) Pub. Date: Dec. 26, 2013

(54) METHOD AND SYSTEM FOR CREATING AN ELECTRONIC HAZARDOUS WASTE MANIFEST WITH VALID SIGNATURE

(71) Applicant: PSC Environmental Services, LLC, Houston, TX (US)

(72) Inventors: James K. Burns, New Castle, NH (US); Michael J. Williams, Wall Township, NJ (US); David Sloat, Cranberry Township, PA (US); Mark Olsen, San Francisco, CA (US)

(73) Assignee: PSC ENVIRONMENTAL SERVICES, LLC, Houston, TX (US)

(21) Appl. No.: 13/974,190

(22) Filed: Aug. 23, 2013

Related U.S. Application Data
(63) Continuation-in-part of application No. 13/274,902, filed on Oct. 17, 2011.
(60) Provisional application No. 61/423,821, filed on Dec. 16, 2010.

(51) Int. Cl. G06Q 10/08

(52) U.S. Cl. CPC G06Q 10/0833
USPC 705/333

(57) ABSTRACT

The present invention relates to methods for creating a manifest for tracking a shipment. The invention can involve obtaining information pertinent to an intended shipment, storing the information in a memory of an electronic device, creating a work order record containing the information pertinent to the intended shipment and storing the work order in the memory. The invention can further involve storing a manifest number in the work order record, generating an electronic manifest record comprising the manifest number and the information pertinent to the intended shipment, and providing a final copy of the manifest, in which the manifest is in an electronic format.

### RELATED APPLICATIONS

The present application is a continuation-in-part of U.S. nonprovisional patent application Ser. No. 13/274,902, filed Oct. 17, 2011, which claims priority to U.S. provisional application Ser. No. 61/423,821, filed Dec. 16, 2010, the contents of each of which are hereby incorporated by reference.

### FIELD OF THE INVENTION

The present invention generally relates to methods and systems for tracking hazardous waste, and more particularly, to an electronic manifest which may be used to track a shipment of waste.

### BACKGROUND

Waste disposal is a huge challenge in the United States. The Environmental Protection Agency (EPA) has estimated that American households generate hundreds of millions of tons of garbage each year, while American industries generate billions of tons of industrial waste each year. Industrial and commercial sources, including factories, dry cleaners, auto repair shops, and hospitals are responsible for producing over 40 million tons of hazardous waste each year.

Before the 1970s, there were few rules regulating waste disposal. Hazardous and non-hazardous waste was often disposed of in unregulated landfills or even discarded in nature. This unregulated waste often contaminated drinking supplies, resulting in illness, birth defects, and death.

The Resource Conservation and Recovery Act (RCRA) was enacted in 1976 to protect people from the dangers associated with waste disposal and to facilitate the clean-up of uncontained waste. The regulations define three classes of actors who handle waste: generators, transporters, and treatment, storage, and disposal facilities (TSDFs). The regulations further define waste as hazardous if appears on one of four hazardous wastes lists (F-, K-, P-, or U-list) or exhibits at least one of four characteristics: ignitability, corrosivity, reactivity, or toxicity. The RCRA also authorizes the EPA to promulgate standards governing hazardous wastes.

Currently, the EPA requires the use of a standard manifest document, known as a Uniform Hazardous Waste Manifest, which must accompany all hazardous waste shipments from the point where the waste is generated to the site of disposal. This manifest is a legal document used to prove chain of custody in the event of a spill, leak, or other issue. The manifest is produced with six copies for each page, with one copy apiece for the various participants in the process (i.e., transporters, treatment facilities, generators, state agencies).

To be compliant, the manifest must include signatures from representatives from the generator producing the waste, the transporter moving the waste, and the treatment facility receiving the waste. These signatures must be legible on all six pages of the manifest form.

The Uniform Hazardous Waste Manifest was designed by the EPA and produced for industrial use by one of several authorized printers. These printers produce hard copy versions of the manifest, which are then run through a dot-matrix style printer to fill out. Current regulations require an original “wet” or ink signature on the form representing the generator, transporter, and treatment facility locations. This wet signature is transferred to manifest copies by a carbon copy built into the form. While the first page of the manifest containing the wet signature is usually legible, the remaining five pages have less legible signatures due to the inability of the carbon copy to adequately transfer the original signature to the remaining pages. The poor quality of the transferred signatures on the remaining pages comprises the effectiveness of the manifest as a legal document for proving chain of custody.

### SUMMARY

The present invention relates to methods and systems for producing an electronic version of the Uniform Hazardous Waste Manifest for hard copy or electronic distribution to the various participants in the waste generation and disposal chain as well as methods for capturing valid electronic signatures on all pages of the manifest form.

The invention provides processes for capturing the information required on a Uniform Hazardous Waste Manifest and merging that data into an electronic version of the manifest form. In certain aspects, the provided electronic manifest includes three sections: a header section, a body section, and a signature section. The body section may include waste profile information, specific weights, waste container type, and number designation. In certain aspects, the invention provides an exact duplicate of the EPA Uniform Hazardous Waste Manifest in an electronic or computer-readable format. While any computer-readable format is useful for practicing the invention, a preferred format is a Portable Document Format (PDF) file, which allows information to be inserted into the header, body, and signature sections using a variety of methods. Such methods include populating the sections from a business application, manipulating the fields for editing, and creating valid signatures using an electronic pen or stylus. The invention also defines in extensible markup language (XML) of the data feeds needed to fully and legally complete the electronic manifest. This method merges the data and form and creates a perfect copy of the manifest with highly legible data on each page of the form.

The invention provides numerous ways in which a signature can be captured onto the encompassed electronic manifest forms. In one aspect, the invention provides an electronic version of the Uniform Hazardous Waste Manifest as described above. The signature of the responsible party is captured on an electronic device, such as a desktop computer, laptop computer, tablet, or handheld device using a stylus. In this aspect, the signature is stored electronically and placed in the electronic version of the form for printing or for electronic transmission to the appropriate parties (e.g., generators, transporters, treatment facilities, state agencies, etc.).

In another aspect of the invention, an electronic version of the manifest is provided as described above. The signature of the responsible party is captured on an electronic device, such as a desktop computer, laptop computer, tablet, or handheld device using a stylus. As above, the signature is stored electronically and placed in the electronic version of the form for printing or for electronic transmission to the appropriate parties. In addition, the signing party would provide additional validation of identity. This could include, for instance, capture all or part of the driver's license number would be linked to the signature and stored electronically. This proof of identity combined with an electric version of the signature further corroborates the identity of a responsible party in the event of a spill, leak, or other mishap.

In another aspect of the invention, the signature is captured using a combination digital pen/ink pen device. This type of pen would provide a standard “wet” signature on the top page of the form, while simultaneously capturing a high quality electronic version of the signature for subsequent printable copies. This electronic version provides an identical match to the original signature that is applied to the duplicate pages of the manifest for printing or electronically distributing to the appropriate parties.

In further aspects of the invention, employee numbers (e.g. generator employees, transporter employees, treatment facility employees) are used in addition to the signatures on the provided manifest forms. Accordingly, confirmation of identity can also be based upon the employee number, which can be linked to the EPA ID Number, the transporter ID number, or the company name. Further embodiments also encompass the use of personnel numbers in lieu of an actual signature.

The invention provides a unique method to print the Uniform Hazard Waste Manifest and its contents in one laser-printed format. This method encompasses both current and future versions of the Manifest. Currently, the EPA requires that six pages of this document be printed. In the future, the EPA under the E-Manifest program will only require one page of the Uniform Hazardous Waste Manifest document to be provided to the transporter. The provided methods are equally applicable to the six page version as well as the single page version.

Other aspects of the invention will become apparent upon review of the following disclosure.

### BRIEF DESCRIPTION OF THE DRAWINGS

FIG. 1 is a block diagram of an exemplary shipment tracking system in accordance with the invention.

FIG. 2 is a flowchart of an exemplary process for producing a manifest in accordance with the invention.

FIG. 3 is a diagram of an exemplary entry of a record in accordance with the invention that can be created, viewed, edited, and composed for printing in relation to the manifest.

FIG. 4 is a perspective view of a handheld device in accordance with the invention.

FIG. 5 is a block diagram of an exemplary process in accordance with the invention for printing the manifest.

FIG. 6 is a perspective view of a printer cart in accordance with the invention.

FIG. 7 is a perspective view of a safety bracket and clamp in the open position, in accordance with the invention.

FIG. 8 is a perspective view of a safety bracket and clamp in the closed position, in accordance with the invention.

FIG. 9 is a perspective view of a switch and power outlet, in accordance with the invention.

FIG. 10 is a perspective view of a manifest paper in accordance with the invention.

FIG. 11 is a perspective view of a notched clipboard and the manifest paper in accordance with the invention.

### DETAILED DESCRIPTION

The invention generally relates to electronic manifests for tracking waste shipments and methods for creating such manifests. The invention can involve obtaining information pertinent to an intended shipment, storing the information in a memory of an electronic device, creating a work order record containing the information in a memory of an electronic device, creating a work order record containing the information pertinent to the intended shipment and storing the work order in the memory. The invention can include the electronic capture of authorized signatures on one or more copies of the manifest. The invention can further involve storing a manifest number in the work order record, generating an electronic manifest record comprising the manifest number and information pertinent to the intended shipment, and providing a final copy of the manifest, in which the manifest is in an electronic format.

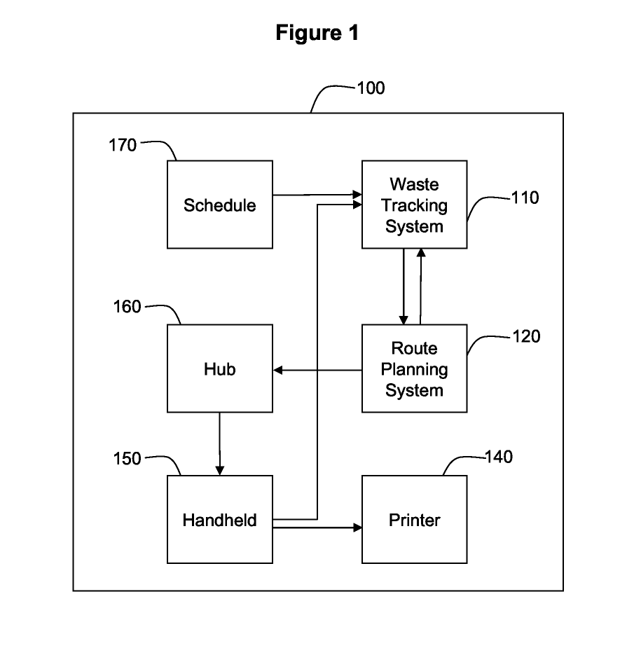

With reference to FIG. 1, a block diagram of an exemplary shipment tracking system 100 is shown. The shipment tracking system 100 may include a schedule 170, a waste tracking system 110, a route planning system 120, a hub 160, a handheld 150, and a printer 140. In other implementations, system 100 may include additional, fewer, or different components.

System 100 may be used to create a manifest such as a printed manifest created via the printer 140. In one exemplary application of system 100, the manifest may contain information describing waste, which may be intended to be shipped. The waste may be hazardous waste, for instance, as defined by RCRA. The manifest may be an EPA Uniform Hazardous Waste Manifest, and may be printed according to processes approved by the EPA. The manifest may be associated with a unique manifest number, which may be printed on the manifest.

Components of system 100 may be separate and distinct objects or functional modules of a single operative system. For instance, any combination of schedule 170, waste tracking system 110, route planning system 120, and hub 160 may be embodied in one computer, with any combination of the remainder of that list being embodied on any number of other computers. Each computer may be a “desktop computer”, with a keyboard, monitor, and mouse, or may be a “server” computer, accessible through a terminal by telnet, SSH, PuTTy, SH, virtual terminal, Virtual Private Network (VPN) or other means.

Any of schedule 170, waste tracking system 110, route planning system 120, or hub 160 may be supplied locally by a software program and/or a database program, supplied remotely by transporter in the form of software program and/or database program, or may be supplied by a third-party as a service, database, and/or program. In one embodiment of the invention, these components are each supplied by one or more modules comprising software, firmware, and/or hardware within a single computer with a processor and a memory. In one embodiment, these components are each supplied by one or more modules comprising software, firmware, and/or hardware associated with a plurality of computers. Any computer, database, or any other electronic device, component, or module of system 100 may be connected to any other such unit by such means the Internet, a WAN, a LAN, an intranet, direct Ethernet or USB connections, infrared connections, or by transferring data using a removable medium such as a disc, CD-ROM, DVD, USB drive, compact FLASH card, external hard drive, or by cellular modem, a 3G or 4G or similar cellular data connections or other communicative couplings.

In an implementation, the schedule comprises information about at least one pick-up event, for example, a scheduled pick-up date or time and the identity or location from which a shipment is to be picked up. In another implementation, the information about at least one pick-up may include information about material to be picked up which could include, for example, the substance and quantity of a hazardous waste to be picked up, the types of materials which are typically picked up from that site, or other information or notes.

The waste tracking system 110 may be configured to generate an open work order in response to receiving information about a shipment from a schedule 170. The waste tracking system 110 may comprise software and a processor. The waste tracking system 110 may be configured to create or open a work order associated with a pick-up event. The waste tracking system may contain a database. The database may be configured to store the work order. The database may contain a process for generating a manifest number or numbers and associating it with the work order. A manifest record or records, which will be described in more detail below, can be created in the waste tracking system 110 and associated with a work order. The manifest record in one embodiment of the invention is associated with a manifest number.

The route planning system 120 may create a route or plan a route, which may comprise information associated with one or more work orders. A route may comprise information regarding one or more pick-up events or work orders to be assigned to a person. Each work order may comprise one or more manifest records.

The route planning system 120 may comprise software and a processor. The route planning system 120 may comprise a database. The waste tracking system 110 and the route planning system 120 may be separate systems or a single system. They may reside on separate computers and transmit data between each other or other components of system 100 via internet means such as email, FTP, “syncing” to a common database, SCP, or other means.

The hub 160 may include an interconnection interface for transmitting a route plan to a handheld. The hub 160 may include an interconnection interface for transmitting data to and/or receiving data from one or more external devices and/or systems located either local to or remote from system 100. The hub 160 may include, for example, a remote computing device or docking station. Wired interfaces may include, but are not limited to, USB ports, RS232 connectors, RJ45 connectors, Ethernet and any combination thereof. The hub may be a remote memory, processor, and/or storage device configured to communicate with any other component of system 100, for instance via FTP, SFTP, email, or other protocol. The hub, like any other component, may be supplied by a third-party, as a service or a rented component, in one embodiment of the invention. In one embodiment of the invention, the hub 160 is a remote email server that receives data via email as sent from route planning system 120 or another component, and is configured to be accessed via the handheld 150 or another component through an email program or web browser. In another embodiment of the invention, the hub 160 is a cable connecting the route planning system 120 directly to the handheld 150, such as a USB cable. In one embodiment of the invention, the hub 160 is connected to the route planning system by a cable, and is configured to communicate directly with the handheld 150 via wireless means, such as a wireless card on each of the hub 160 and the handheld 150.

In another embodiment of the invention, the hub 160 is a component of the route planning system 120 comprising computer program instructions and/or communication means, and is capable of communicating with the handheld 150 wirelessly or via a cable. In another embodiment of the invention, communication between any two components of system 100, such as the hub 160 and the route planning system 120, or the hub 160 and the handheld 150, is accomplished via such wireless means as Wi-Fi, Bluetooth, or infrared or wired means.

A handheld 150 may be supplied by a handheld Electronic Digital Assistant (EDA), a tablet computer, a laptop computer, a smart-phone, a computer, or another electronic device. The handheld 150 is configured to receive and store a work order and/or a manifest record, and to allow the manifest record to be edited. The handheld 150 is configured to compose a manifest record for printing. In one embodiment of the invention, the handheld 150 is configured to receive an electronic signature. In one embodiment of the invention, the handheld 150 is configured to cause a printer to print a manifest based on a manifest record. The handheld may also be configured to generate an electronic copy of the manifest based on the manifest record. The electronic copy can be in a number of electronic, computer-readable formats. In one embodiment, the electronic format is a Personal Document Format (PDF) file. In another embodiment, the electronic format is stored in a defined extensible markup language (XML) file, that is then merged into a PDF document for printing and storage.

In one embodiment of the invention, the handheld 150 is configured to transmit information relating to a pick-up event, a work order(s), a manifest record(s), a manifest number(s), or a manifest(s) to waste tracking system 110, either directly or via a hub 150 or other communication means, and either in real-time or via periodic synchronizing.

A printer 140 is capable of printing a manifest. The printer 140 may be a laser printer such as a Lexmark or other brand of printer. The printer 140 is configured to receive material to be printed wirelessly, from handheld 150.

In one embodiment of the invention, printing progress can be monitored via an interface 410 on the handheld 150. In one embodiment of the invention, an operating system on handheld 150 has a control panel module that supplies access to a printer interface, which can provide information about the status of the printer 140 or the progress of a print job. In one embodiment of the invention, system 100 provides a software component on handheld 150. Software on handheld 150 can be configured to perform steps of the invention responsive to information about the status of printer 140 or the progress of a print job. In one embodiment of the invention, successful printing of a manifest causes a handheld 150 to perform a step, which may include generating a prompt to obtain a signature or sending data to a waste tracking system 110 about a work order or a manifest.

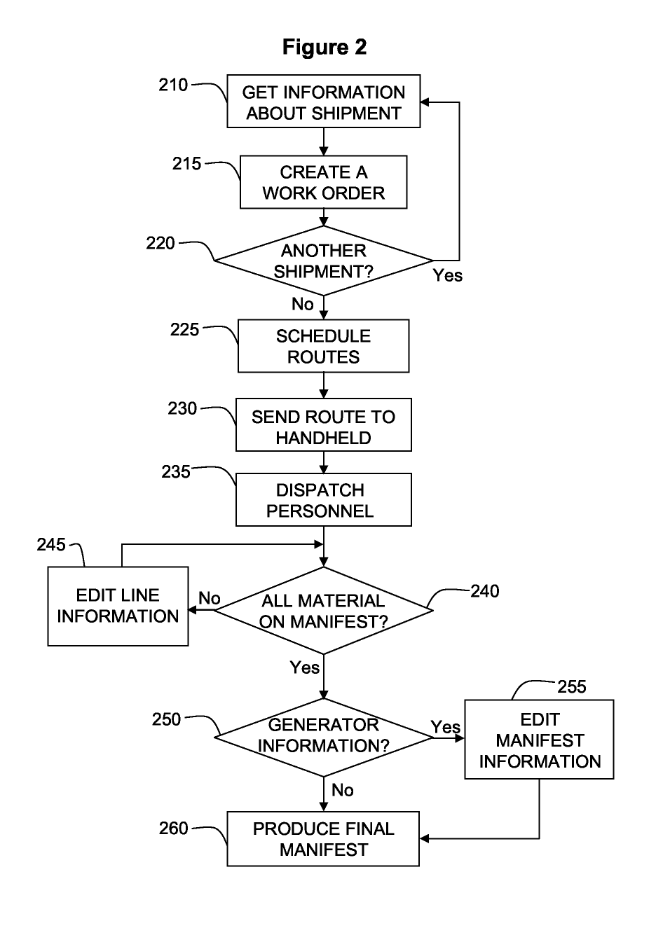

Turning now to FIG. 2, a flowchart of an exemplary process for producing a manifest is disclosed. The process of FIG. 2 may begin with obtaining (block 210) information about a shipment from a schedule 170. In one embodiment of the invention, an open work order will be created (block 215) in waste tracking system 110 based on information from schedule 170. In one embodiment of the invention, the schedule 170 is finalized about one week prior to the pick-up event. An open work order may be associated with manifest record 300. An open work order may contain information not specifically associated with a manifest record as well as information comprised by the manifest record 300. Information which the open work order may comprise includes: date and location of a pick-up event; identity and/or address of a customer or generator of waste; information identifying a person who created the work order, scheduled the route, or is assigned the pick-up; information specific to the material or waste to be picked up; a manifest number; and/or other information.

Each open work order may contain header information and supply that information to a manifest record to be supplied to a manifest. Header information can include the name, identity, mailing address, physical address, and representative name of a customer, generator, transferor, TSDF, or other pertinent parties. Any other identifying indicia may be included in the header information. If a customer and/or generator has a billing and mailing address distinct from the address of the pick-up event, both may be included.

Components of the header information may be obtained from the database, for instance, based on prior shipping transactions, from the schedule 170, over the telephone, email, or internet, from a directory or other reference, or from the knowledge of a person. A person and/or process within waste tracking system 110 will create the header information based on these components and associate it with an open work order so that it can be used to create a manifest, in one embodiment of the invention.

At the time the open work order is created, the waste tracking system 110 will generate a manifest number. The manifest number may be generated automatically, and parameters can be set to ensure that the auto-generated number will never repeat. The generated manifest number will be stored in a manifest record 300. Waste tracking system 110 will allow a person to edit the manifest number, for instance, in cases in which the generator has supplied their own manifest number or will be supplying their own paperwork. The waste tracking system 110 can prevent a person from hand-entering a manifest number that has already been created or used by the waste tracking system 110. This can be accomplished, for example, by refusing to accept manual entry of numbers previously generated by the waste tracking system 110.

In one embodiment of the invention, the shipment tracking system 100 is operated substantially by a single transporter entity. That transporter entity is an EPA approved transporter of hazardous wastes and is registered with the EPA as a printer or creator of uniform hazardous waste manifests. According to this embodiment, the transporter entity will only accept for use a manifest bearing a unique manifest number. Any manifest number generated by the transporter will end in a three-letter suffix approved by the EPA. In this embodiment, a person can only enter third-party manifest numbers into a manifest record via the waste tracking systems when they do not end in the three-letter suffix associated with the transporter. In another embodiment, a person can only enter a third-party manifest number when they end in a three-letter suffix associated with an EPA approved entity other than the transporter.

Once a work order has been created, it is determined (block 215) if the schedule contains information about another shipment. If there is information about another shipment, then that information is obtained (block 210) and another work order is created (block 215). If or when an open work order is created for each shipment indicated by the schedule 170, the work orders will be used to schedule routes (block 225). In one embodiment of the invention, the work orders are created (block 215) once each week, based on a schedule that has been finalized about one week beforehand. In this embodiment of the invention, a “week's schedule” describes those work orders created in a week, based on a schedule finalized about one week beforehand, as well as any associated route information and other information.

In another embodiment of the invention, the time between finalizing the schedule and creating the work orders, as well as the periodicity of creating the work orders, can be another measure of time, such as daily, monthly, annually, or any other period. In another embodiment of the invention, either the schedule is finalized or the work orders are created on an ad hoc or as-needed basis. In another embodiment of the invention, a person or the waste tracking system 110 can determine the time to perform any steps of the process based on inputs from a person, inputs from the generator or customer, or calculations made within system 100.

Once all the open work orders are created, they are optionally supplied to route planning system 120. Route planning system 120 can schedule (block 225) one or more routes. Scheduling (block 225) a route can comprise choosing one or more of the work orders and assigning them to a transporter person. A route can be scheduled (block 225) based on geographical logic—that is, a list of pick-up sites that can realistically be visited in a set amount of time such as eight hours of a day. In other embodiments of the invention, a route can be scheduled based on other criteria, such as a request made by a transporter person, availability of vehicles, professional determinations of a person, historical route patterns, other factors, and any combination of these. In one embodiment of the invention, route planning system 120 can access a mapping, GIS, or GPS program, which can be within the system 100 or can be supplied externally to schedule (block 225) a route. In one embodiment of the invention, a route comprises a set of work orders each corresponding to a pick-up event, which is to be assigned to a transporter person. In one embodiment of the invention, a route contains a work order and an associated manifest record(s) that comprises header information and a manifest number(s). In one embodiment of the invention, routes are not scheduled, and work order is transmitted directly to handheld 150. According to this embodiment of the invention, after work order is created (block 215) it can then be sent (block 230) to handheld 150 and system 100 need not have route planning system 120.

After a route is scheduled (block 225), it is sent to a handheld 150 (block 230). A hub 160 may be employed to transfer or copy a route from route planning system 120 to handheld 150. The hub 160 may be wireless. In one embodiment of the invention, the hub 160 comprises a wireless router supplying a local Wi-Fi network. The handheld 150 and route planning system 120 each comprise a wireless card and software to communicate between them over the wireless network. In one embodiment of the invention, software on either the handheld 150 or the route planning system 120 can initiate the transfer either automatically at scheduled intervals, or automatically responsive to proximity and/or completion of route scheduling (block 225) or at the initiation of person. In another embodiment of the invention, the hub 160 comprises email service and access software, or other means for transferring data from route planning system 120 to handheld 150. In one embodiment of the invention, a person may enter a route directly into handheld 150, for instance by a keyboard or input means on the device, responsive to knowledge of routes obtained from the route planning system 120.

A person may be dispatched (block 235) to a pick-up event, said person having custody of handheld 150 with a route stored thereon. In one embodiment of the invention, the person can travel to the pick-up event with a vehicle.

When a person arrives at the pick-up site, they can open the work order for that specific pickup via the handheld 150, for instance by accessing the work order through the user interface (UI) of the handheld.

A person can access information about the pick-up event, such as location or time, by consulting the work order, stored in the route within the handheld 130. In one embodiment of the invention, a person may consult the work order in the handheld 150 and may further consult a manifest record 300. The manifest record may comprise information that can be presented on the screen of handheld 150. The manifest record as presented on the screen of handheld 150 may be composed for the screen to represent the form of a manifest. At the pick-up event, a person may examine the material that is to be picked-up for shipment, and may consult the manifest form presented on the screen of handheld 150.

A person may determine if all of the material to be shipped is listed as lines of information on the manifest form (block 240). If it is not, a person may edit the line information (block 245), for instance, by entering new line information, for instance via the UI of handheld 150. In one embodiment of the invention, a person enters line information into handheld 150 by choosing or entering a waste code. A waste code can be entered by scanning a barcode. A barcode for scanning may be on a list of frequently used waste codes stored in the vehicle or on a waste container. For instance, the transporter vehicle may have waste containers for receiving the generator's waste, and each such container may bear a barcode.

For each line that is entered—either by scanning a barcode, selecting a waste code from a list or menu, or entering information identifying waste—information about quantity, weight, number of containers and container type and/or size, may be entered as-needed.

In one embodiment of the invention, waste is sorted into transporter's containers in or on the vehicle. In another embodiment, generator has pre-sorted the waste, and the pre-sorted waste is transferred, for instance, on a container-by-container basis, into transporter containers in or on the vehicle. In another embodiment, entire containers of waste are transferred from the generator site into or onto the vehicle.

The determination and editing steps (blocks 240 and 245, respectively) are repeated until the manifest record comprises an accurate description of the material to be shipped.

When the generator supplies information related to the shipment (block 250), it is determined whether to edit (block 255) the manifest record to contain the generator-supplied information. In one embodiment of the invention, the generator-supplied information may be a manifest number, updated header information, supplementary header information, notes, or other information. In another embodiment of the invention, the generator may provide as information the fact that they are supplying their own paper manifest. Responsive to this information, appropriate action may be taken, including, without limitation: editing the manifest number in the manifest record 300 based on the manifest number appearing on the generator-supplied manifest; editing the manifest-number in the manifest record 300 to a code number which indicates a generator-supplied paper manifest; causing the manifest record to not be printed; sending information to waste tracking system 110 pertinent to the generator-supplied manifest; or suspending or initiating any other process.

After all line information is entered, and after any appropriate generator-supplied information is entered, handheld 150 may prompt a person to generate the final manifest. In one embodiment of the application, the data will be created as an extensible markup language (XML) document that will be stored locally on the handheld and/or uploaded to centralized database.

A final manifest is produced once the manifest information is finalized (block 260). In one embodiment of the invention, producing the final manifest comprises generating an electronic copy of the manifest, as described in further detail below. In another embodiment of the invention, producing a final manifest comprises the steps of: printing the manifest record; obtaining a manual signature on the paper manifest; or obtaining an e-signature via handheld 150. In one embodiment of the invention, a manifest printer, which will be described in more detail below, is mounted in the transporter vehicle. Handheld 150 causes the manifest printer to print the manifest. If the manifest prints incorrectly—if the printer jams, if the manifest contains a mistake, if additional lines of information must be added—the first printing is destroyed and the manifest is subsequently re-printed using the same manifest number. Once the manifest prints correctly, the printed manifest can be signed by a representative of the generator, who can also sign the handheld 150 electronically, thereby providing an e-signature to be stored in record 300 or elsewhere in system 100. As already mentioned, the e-signature can also be stored in an electronic copy of the manifest.

An e-signature according to one embodiment of the invention is an electronic indicia, created via an input means such as a touch-screen, keyboard, stylus, button, or camera, with the intent that it represents a signature of a signatory, and capable of being stored on a computer-readable medium.

In one embodiment of the invention, acceptance of the e-signature will lock the manifest number from additional changes. In one embodiment of the invention, the UI of handheld 150 will be updated to lock the manifest data once the signature is accepted. In one embodiment of the invention, acceptance of an e-signature, a hand-written signature, or both indicates production (block 260) of the final manifest. When the final manifest has been produced, system 100 or waste tracking system 110 can refuse to accept any changes to a manifest record associated with that manifest number.

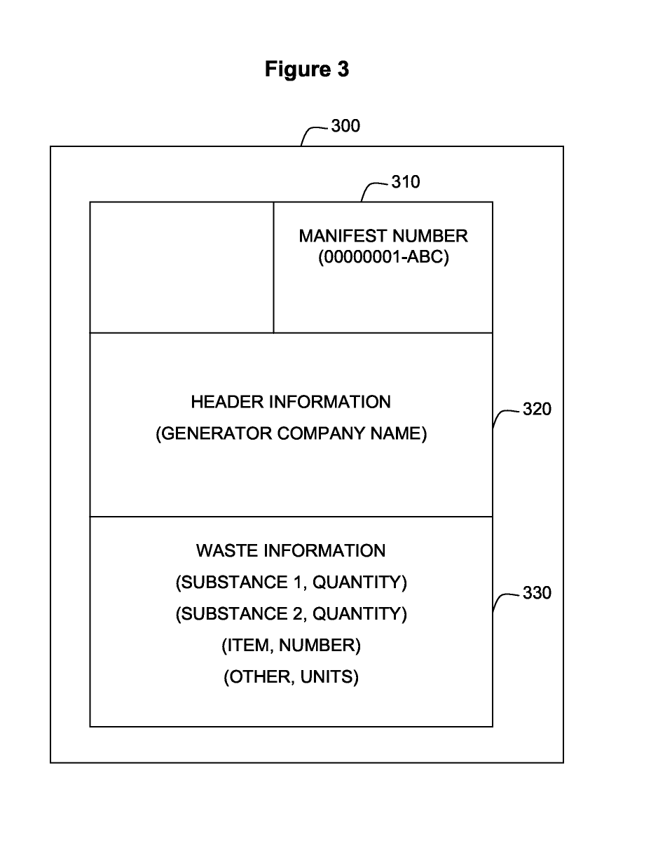

Turning to FIG. 3, a diagram of an exemplary record 300 that can be associated with a work order, and created, viewed, edited, and composed for printing to supply a manifest is shown. The record can also be used to supply an electronic copy of the manifest. In one embodiment of the invention, a record 300 may serve as an open manifest record created by waste tracking system 110 and transmitted to handheld 150. The record 300 may contain fields for information necessary to produce an EPA uniform hazardous waste manifest. In one embodiment of the invention, waste tracking system 110 automatically generates a manifest number and supplies it for the manifest number field 310. A header information field 320 may include header information supplied by person when a work order is created (block 215), and that header information may subsequently be edited as-needed via handheld 150. Waste information field 330 may include information about waste to be shipped Lines of waste information may be supplied by a schedule 170, a person when a work order is created (block 215), a database in a waste tracking system 110, edits performed by a person upon a determination (block 240) that all waste to be shipped is not yet listed in the field, or edits performed when a mistake is discovered on a manifest, for instance.

A record 300 can contain additional information not depicted here. For instance, in one embodiment of the invention, a printed final manifest is six sheets long and manifest paper does not have preprinted routing instructions or page numbers. According to this embodiment of the invention, record 300 can contain information to supply page numbers, sheet numbers, or routing instructions when a manifest is printed. In one embodiment of the invention, a manifest may be printed on a color printer, or composed for printing or digital transmission using software which preserves or represents color information. In this embodiment of the invention, record 300 can contain information about what color different portions are intended to be printed in. In one embodiment of the invention, material from some fields, such as manifest number 310, header information 320, and waste information 330, is printed or displayed in black, while other information, such as page numbers, sheet numbers, or routing instructions are printed or displayed in the borders of the document.

The information in manifest number field 310 is shown in FIG. 3 as “000001-ABC” although any suitable number may be used, provided the number has not been used previously. Similarly, the information in header information field 320 is shown as “generator company name”, although other information may be recorded here. For instance, header information field 320 can contain a name of a generator company, a mailing address, a pick-up address, GPS coordinates, a URL, a phone number, a person contact name, notes, custom fields of text, or anything else. The information in waste information field 330 is shown in FIG. 3 as “substance 1, quantity” and other exemplary lines, but can contain any useful description of the contents of a shipment, such as DOT (Department of Transportation) shipping, description, or can be left blank for a period until more information is obtained. In one embodiment of the invention, each line contains a description of material to be shipped, and the description comprises the identity of the material as defined by the US DOT, a quantity, weight or other unit of measure, optionally information about its packaging or condition, and/or other information.

In one embodiment of the invention, record 300 is configured to accept up to four lines of information in waste information field 330. Upon entry of one more line of information, waste tracking system 110 generates a new record 300, sharing the same manifest number, and designated as a continuation of the first record. A continuation record can accept up to ten lines of information in continuation waste information field 330. If one more line of information is entered, another continuation record is created, and so on. In this embodiment, a manifest record comprises a record 300 and each continuation record 300. In an alternative embodiment, each initial page can contain a number of lines other than ten, and entry of an additional line causes the creation of a continuation record 300. In one embodiment of the invention, a record 300 can contain one number of lines of information, and each continuation can contain another number of lines.

Record 300 supplies the information to be printed on a manifest or used to populate the electronic copy of the manifest. Each continuation record 300 supplies information to be printed on a continuation of a manifest. Each record and any associated continuation, as well as each manifest and any associated continuation, in one embodiment of the invention, share a manifest number.

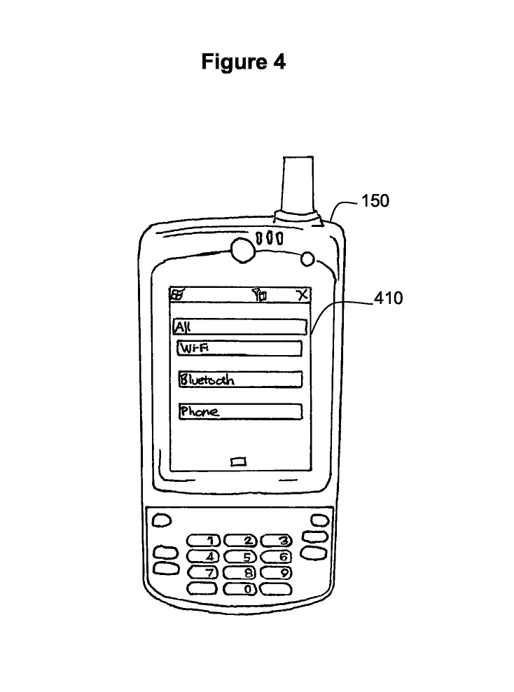

Referring now to FIG. 4, an illustration of handheld 150 is disclosed. Handheld 150 may appear substantially as illustrated in FIG. 4 as an Electronic Digital Assistant (EDA) in one embodiment of the invention, or handheld 150 may appear as another devices such as a tablet computer, a laptop, a Smartphone, an iPhone or blackberry device, a custom-built device, a computer or other device.

A handheld 150 will have an interface 410 for displaying and editing information. In one embodiment of the invention, the interface 410 comprises a screen an alpha-numeric keypad. In one embodiment of the invention, the interface 410 comprises a touch-sensitive screen. In one embodiment of the invention, the interface 410 can display a QWERTY keyboard for input via a touch-sensitive screen. In one embodiment of the invention, handheld 150 has at least one USB port capable of connecting to a keyboard, mouse, or other input device. Interface 410 can include an interface capable of accepting input from a stylus. Handheld 150 can comprise a Wi-Fi card, a 3G cellular data card, a 4G cellular data card, other cell-phone network connectivity hardware, an Ethernet port, an infrared data port, a USB connection, or other means for transferring data. In one embodiment of the invention, handheld 150 is capable of exchanging data with route planning system 120, either directly or via hub 160, exchanging data with a waste tracking system 110, and/or communicating with a printer 140 to cause a document to be printed and to report a printer status or progress.

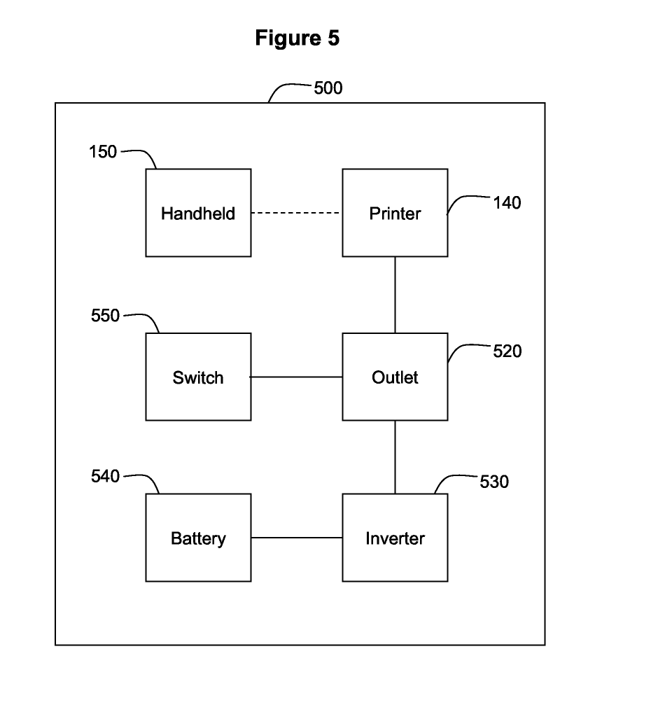

Turning now to FIG. 5, a block diagram of an exemplary printing system 500 for printing a manifest is disclosed. In one embodiment of the invention, printing system 500 is configured to be taken to a pick-up event, for instance, by a vehicle. In one embodiment, the vehicle supplies a battery 540. Power from the battery is supplied to an outlet 520 via an inverter 530. A connection between outlet 520 and battery 540 can be alternatively opened or closed by switch 550. Outlet 520 can supply a standard electrical outlet. In one embodiment of the invention, a standard electrical outlet is housed in a protective cover, which can be rugged or lockable. Printer 140 can be plugged into outlet 520 by means of its power cord. A handheld 150 is communicatively coupled to printer 140. In one embodiment, printer 140 is a Lexmark or similarly branded printer. Handheld 150 can wirelessly link to printer 140.

In one embodiment of the invention, handheld 150 has a wireless (Wi-Fi) card. When the wireless card is turned on, the handheld can automatically find and connect to the printer if they are within range of each other, for instance, 80 feet or some other distance. Interface 410 in FIG. 4 presents a network connections menu on a screen of handheld 150 in one embodiment of the invention. In this embodiment, a person can tap or click on the Wi-Fi field area of the screen to turn on the Wi-Fi card. In other embodiment of the invention, the handheld device will utilize a Bluetooth wireless connection to the printer.

When all of the desired waste is listed in record 300 or a continuation, and stored on the handheld device in an electronic format (such as XML or PDF), a person may so indicate and be prompted to, or may choose to, print the manifest. In another embodiment of the invention, the data entered for a single work order will be able to be printed onto multiple manifests or documents depending on the regulatory rules for the waste, the destination of the waste, and the preference of the generator. Handheld 150 can compose a record 300 into an electronic format such as XML and merge that data into a finalized format, such as PDF, for printing and send it to printer 140.

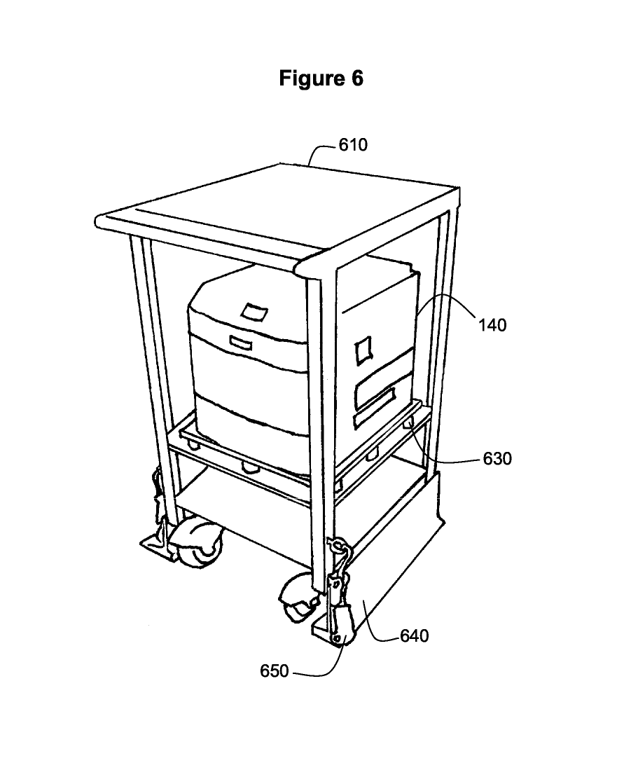

FIG. 6 is a perspective view of printer 140 mounted on shock-absorbing cart 610 in a vehicle according to one embodiment of the invention. By providing printer 140 in or on a vehicle, the invention enables the manifest to be printed directly at the point of pickup. This process can create clean and highly legible manifests that list only and exactly the waste which is picked up at the generator. In one embodiment of the invention, shock absorbing cart 610 is installed in the back of a truck. The cart may be secured to the vehicle by means of at least one floor bracket 640 and at least one clamp 650, or utilizing another restraining strap. A platform of the cart is provided with shock absorbers 630.

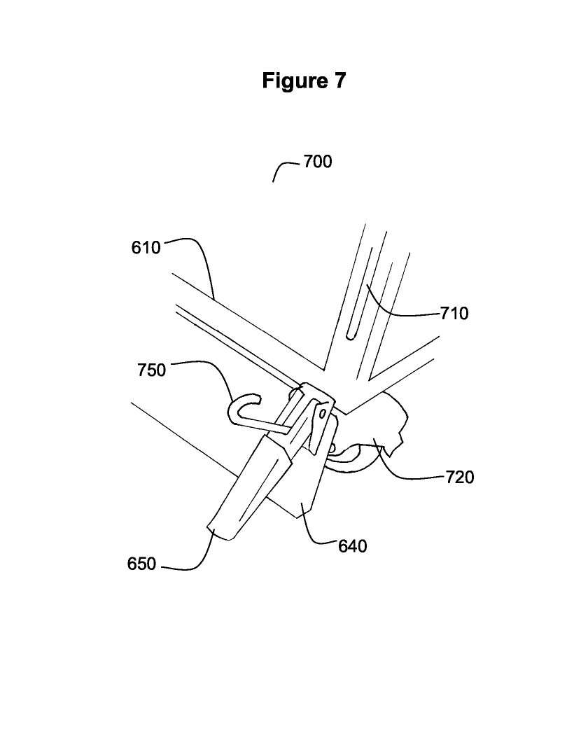

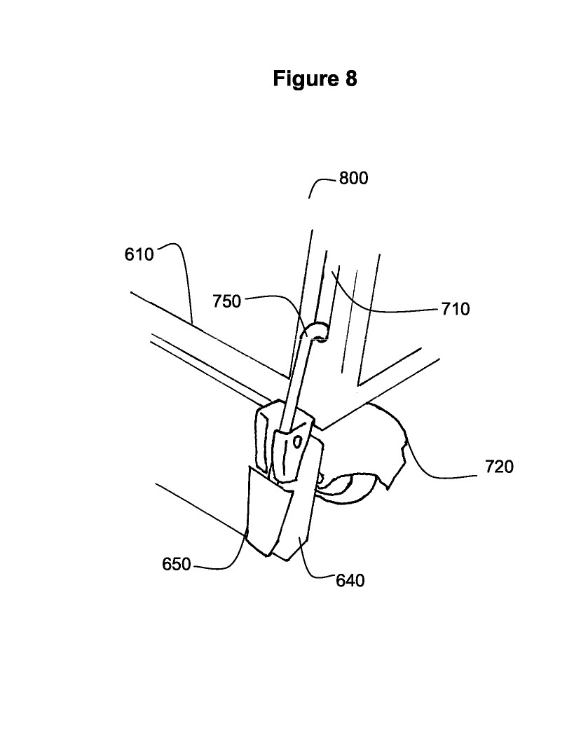

Looking at now at FIG. 7 and FIG. 8, perspective views of a safety bracket 640 and a safety clamp 650 in an open and closed position, respectively, according to one embodiment of the invention are shown. A securing system in configuration 700 allows printer cart 610 to be moved. In configuration 800, printer cart 610 is secured in place to protect it and containers of waste when the vehicle is moved. A safety bracket 640 is secured to the floor, for instance, by bolts. In one embodiment, safety bracket 640 is at least tall enough that a wheel 720 could not roll over it. In a preferred embodiment, an edge of bracket 640 engages against an edge of the frame of cart 610 to hold cart 610 substantially in place. Clamp 650 includes a hook 750 configured to engage an opening 710 on a cart 610. In one embodiment, opening 710 is a slot in a portion of cart 610. In an alternative embodiment, opening 710 is an eyelet mounted to cart 610. In one embodiment of the invention, after hook 750 is engaged in opening 710 clamp 650 is locked in the closed position. In one embodiment, clamp 650 is locked in the closed position by means of a pin (not pictured) inserted through holes in the clamp assembly. In an alternative embodiment, clamp 650 may be secured in the closed position by means of a cam fixed to an axle mounting the clamp handle to the clamp base (not pictured) and configured to exert a minimal amount of pressure when the handle is in the closed position but to exert considerably more pressure against clamp base as the clamp handle is rotated towards the open position. In another embodiment of the invention, cart 610 is secured in place by nylon bands tied or fastened, for instance, to a mounting bracket installed in the sidewall of the truck. When the safety clamp 650 is in the closed position depicted within configuration 800, cart 610 does not roll when the vehicle moves.

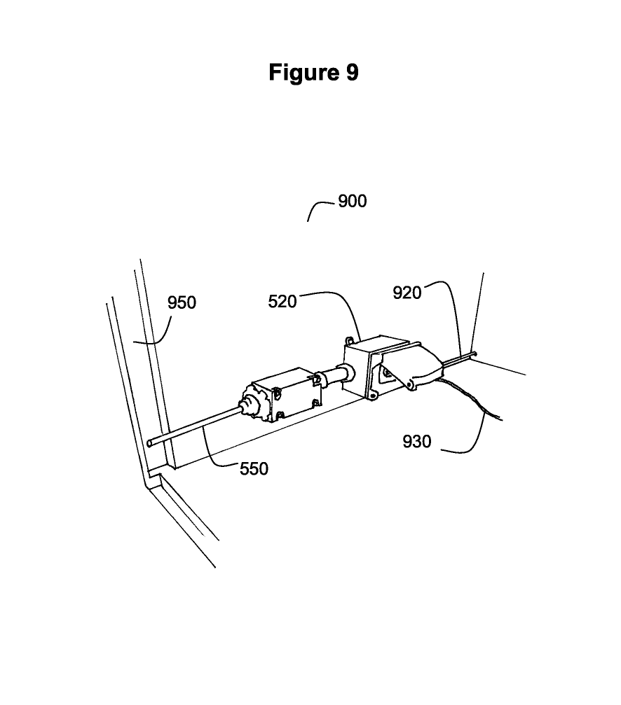

Referring to FIG. 9, a perspective view of switch 550 and power outlet 520 according to the present invention is disclosed. In this embodiment, the power outlet 520 is mounted within the vehicle cargo area 900. The outlet is wired to a magnetic trip switch 550 arranged to be triggered by a door of the vehicle. In this embodiment, the door can be opened or closed by sliding along door guide track 950. When the door is down, switch 550 breaks a connection between plug 520 and either battery 540 or inverter 530. Outlet 520 is connected by connection 920 to inverter 530 (not pictured here) which is connected to the vehicle battery 540 (not pictured here). In one embodiment of the invention, the inverter is mounted under a seat. In one embodiment of the invention, the vehicle is a truck, and the inverter is mounted under a passenger seat. In one embodiment, the inverter is a DC/AC Power Inverter or similar device. When the door is open, outlet 520 receives power. Printer power cord 930 is shown plugged into outlet 520. In another embodiment, switch 550 is a toggle switch, for instance, like a common light switch, which can be operated by person on an as-needed basis.

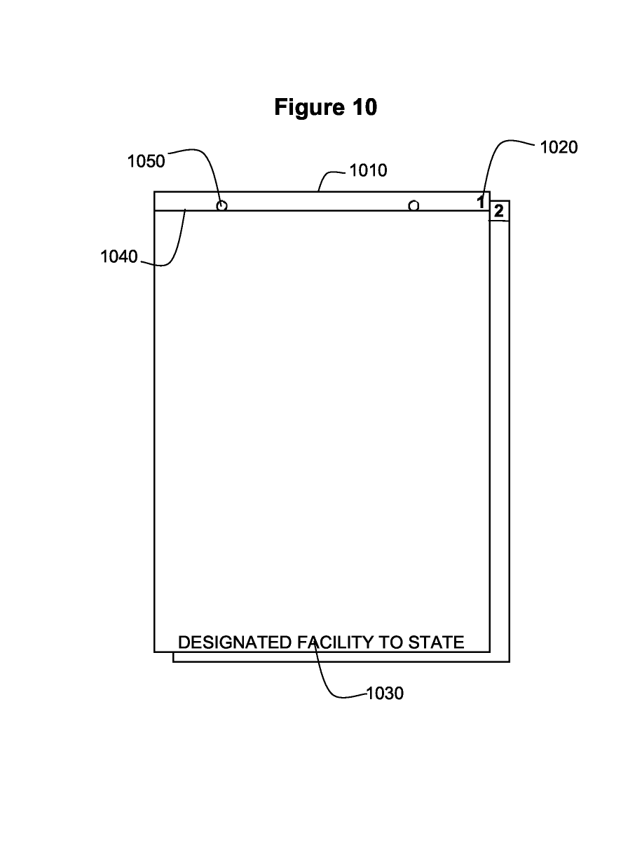

Turning now to FIG. 10, manifest paper 1010 is shown. In one embodiment of the invention, to produce a final manifest requires the production of six total copies (e.g., one “original” plus five additional “copies”). In this regard, a “one page” manifest would require six sheets of manifest paper and would result in six printed sheets, each substantially similar with regards to manifest number, header information, and waste information.

In one embodiment of the invention, each “initial page” of a manifest can contain up to four lines of waste information. Accordingly, a manifest with four or fewer lines of information would be a “one page” manifest and would require six sheets of manifest paper 1010. A manifest with five or more lines of information would be a “two page” manifest—comprising a first page and one continuation page—and would require 12 sheets of manifest paper 1010. Further, a manifest with 14 or more lines of information would be a “three page” manifest—comprising a first page and two continuation pages—and would require 18 sheets of manifest paper 1010. More lines of information would lead to the creation of manifests with more pages and sheets according to the pattern established by these examples.

In one embodiment of the invention, each page of a manifest corresponds to one form 300. Each page is printed six times, using six sheets of paper, yielding six copies of the manifest. For a one page manifest (i.e., with four or fewer lines of information) the manifest number field 310, the header information field 320, and the waste information field 330 is the same across all six sheets. For a manifest with a number, N, of pages the manifest number field 310 and the header information field 320 are the same or substantially similar across all N pages and all 6N sheets, but the waste information field 330 varies from page to page.

Further, each of the six sheets bearing a copy of a page of a manifest contains uniquely printed portions, according to an embodiment of the invention, either pre-printed on manifest paper 1010, or printed during a pickup event. As an example, the first sheet may need to be printed with one set of instructions or routing information, or one passage quoted from the Code of Federal Regulations (CFR), or one particular set of blank areas for signatures or initials, and each subsequent sheet—corresponding to the same page and the same form 300—may need to be printed with its own set of instructions or CFR passage or blank area.

Further, each sheet of the manifest may be required to have printing on both sides. In one embodiment of the invention, this is accomplished by a printer capable of printing on both sides of a sheet of paper simultaneously and automatically, without manual reloading or intervention by a person. In one embodiment, both sides of each sheet are printed by a printer capable of printing on each side automatically and sequentially, without manual reloading or intervention, such as a HEWLET-PACKARD LaserJet P2055dn. In another embodiment of the invention, the front pages of the form will be printed in order, and a manual step will occur to turn the printed pages over and reprint the same pages again on the back side. In another embodiment of the invention, the backs of the sheets of manifest paper 1010 are pre-printed as well as the pre-printed numbers 1020 and pre-printed routing instructions 1030. In one embodiment, the printing on the backs can be any color, for instance, black. In one embodiment, each of the six sheets has unique printing on the back, for instance a passage of the CFR or instructions or contact information for the transporter.

Further, each of the six sheets bearing a copy of a page of a manifest is printed with a sheet number 1020 and routing instructions 1030. In one embodiment of the invention, the manifest paper 1010 is prepared in sets of six sheets, wherein the sheets of each set each bears a pre-printed page number 1020 and pre-printed routing instructions 1030. In this embodiment, one set (six sheets) of manifest paper 1010 is loaded into printer 140 for each page of a manifest. Routing instructions may be different on each sheet and may include any printing. Routing instructions here refers to any information pertinent to a sheet of the manifest or pertinent to the generation or handling or legal status of the manifest or the contents of the shipment.

After all of the waste is listed in record 300 or a continuation record, handheld 150 can compose each record 300 for printing and send it to printer 140. Handheld 150 can compose six different sheets to be printed for each record 300, and send those digital compositions to printer 140. Thus, printing one page of a manifest correctly, according to one embodiment of the invention, will use exactly one set, or six sheets, of manifest paper 1010. For these reasons, if a paper jam occurs while printing, it can be important that the paper jam be cleared, unused sheets of one set of manifest paper be removed, the print job be canceled, the partially printed set be destroyed, and that printing be re-started anew.

Remembering now that each sheet of a set of manifest paper 1010 is pre-printed with unique numbers 1020 and unique routing instructions 1030, and also remembering that handheld 150 may compose each sheet uniquely, it can be appreciated that printing according to these steps of the invention will produce a manifest comprising six copies (i.e., sheets) of each page, wherein each copy has some unique information presented and some common information presented. Further, if the printer prints in one color (e.g., black) and if the pre-printed numbers 1020 or routing instructions 1030 are in a second color, each sheet of a manifest will have: a manifest number, header information, waste information, and some unique sheet-specific information printed in black, as well as a unique sheet number and unique routing instructions printed in the second color. Further, each sheet of a correctly printed manifest may have unique printing on the back.

Because of the number of requirements associated with a correctly printed manifest, to correctly produce (block 260) a final manifest, a person should validate proper printing before stapling or obtaining signatures. To validate proper printing, a person should examine at least the following criteria: all six sheets of each page are printed properly, on both sides where applicable; the pages are in proper order; any pre-printed information is oriented correctly relative to any newly-printed information; all printing is clear and legible, with no hints of low toner, streaking, or other blemishes; and the sheets have been printed with good registration so that printed material appears correctly positioned on each sheet and does not exhibit printing drift among sheets.

Manifest paper 1010 according to this embodiment of the invention is “carbonless” paper, sometimes referred to as No-Carbon Required or NCR paper. After one page of a manifest is printed onto six sheets of manifest paper 1010, those sheets may be collated into an assemblage and placed on a firm surface. If the top sheet is thereafter written on firmly with a ball-point pen or similar, each of the remaining five sheets will take a copy of that writing. By virtue of this phenomenon, one signature can be collected and it can appear substantially similarly on each sheet of that page of the manifest.

Referring still to FIG. 10, further aspects of manifest paper 1010 are disclosed. The manifest paper is pre-drilled with pre-punched guide holes 1050. The top portion, which may be ½ inch, of manifest paper 1010 constitutes a tear-off strip separated from the remainder of the paper by a separation line 1040. In one embodiment of the invention, separation line 1040 includes perforations to enable clean removal of the tear-off strip. In another embodiment of the invention, separation line 1040 is a printed line, indicating a portion of the sheet that may be cut off, otherwise removed, or disregarded.

In one embodiment of the invention, manifest paper 1010 measures 8.5 inches by 11.5 inches. In this embodiment of the invention, when the half-inch tear-off strip is removed, the remaining paper is 8.5 inches by 11 inches.

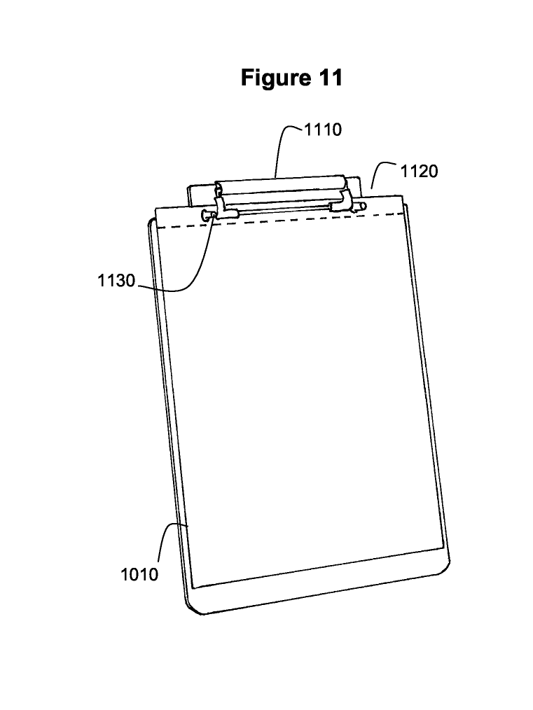

With reference to FIG. 11, a perspective view of a clipboard 1110 holding manifest paper 1010 is shown. The clipboard 1110 has at least one notch 1120 configured to expose both sides of an area of a printed manifest. The clipboard 1110 has at least one peg 1130 designed to fit a pre-punched hole 1050 in manifest paper 1010. In one embodiment of the invention, a notch 1120 is formed by cutting away a corner of standard rectangular clipboard. In one embodiment of the invention, a clipboard 1110 has two notches 1120, each of which exposes a portion of the tear-off strip of manifest paper 1010.

Clipboard 1110 allows a person to easily compile the six copies of each form that are printed. Each peg 1130 mounted on clipboard 1110 can be designed to fit one pre-punched hole 1050 in manifest paper 1010. Each cutout corner, or notch 1120, can guide the stapling of the six sheets together into a single form. To use clipboard 1110, a person aligns the six sheets of a manifest page, places each hole 1050 over a peg 1130, and lowers the spring clip over the paper 1010. The manifest can then be stapled in the upper right and upper left of the form. The clipboard notch 1120 in each corner will guide this process to make sure that the staple does not go below the tear-off strip at the top of the page. This process may be repeated for each manifest and each continuation page.

In one embodiment of the invention, the sheets are secured using a plier stapler, such as an Office Max Full Strip Plier Stapler, an Elmer's Rapid R1 Plier Stapler, a Rapid Classic 1 Plier Stapler (model number 90119), a SWINGUNE-brand commercial hand stapler, model number 29940, or another hand-held stapler. In one embodiment of the invention, this stapler has a lower lip that presents a minimal protuberance so that the clipboard does not interfere with stapling the manifest within the tear-off strip.

In one embodiment of the invention, producing the final manifest (block 260) includes the steps of printing the paper manifest, assembling the paper manifest, obtaining a hand-written signature on the paper manifest, and/or obtaining an e-signature on record 300 via handheld 150. Assembling the paper manifest includes putting each set of six sheets corresponding to one page of the manifest onto clipboard 1110, stapling the sheets together, and presenting the manifest to a generator representative for the hand-written signature. In one embodiment, the invention includes a heavy, wide-tip pen, which serves to ensure that the representative's signature copies through all sheets of the manifest, and appears legibly on each of the six sheets. To facilitate this result, the manifest is kept on the clipboard, and the clipboard is placed on a hard surface for the signature. In another embodiment of the invention, the printer prints only a single copy of the manifest form which is signed with a specialized pen. This pen allows for a legal ink signature for the single page, but the pen stores an exact electronic duplicate of the signature, which is used to create an electronic signature for pages 2 to 6 of the manifest.

In one embodiment of the invention, a person compares the representative's signature on the manifest to an approved exemplar, which may be, for example, a previously-obtained copy of the representative's signature on a laminated sheet stored in the transporter vehicle.

In one embodiment of the invention, producing a final manifest (block 260) requires representative's signature to appear legibly on each sheet. To ensure this end, a person visually inspects each sheet after signing. If the signature is not legible on any of the six sheets, the representative re-signs the sheet in question.

It will be appreciated from reading the foregoing that manifest paper 1010 must always be loaded into the printer 140 with the correct orientation to ensure that manifest information is printed on the same side of manifest paper 1010, and in the same orientation, as the pre-printed routing instructions 1030. The proper orientation of paper 1010 in printer 140 is also required for the carbonless paper phenomenon to be advantageously employed. To this end, an icon or image may be displayed on or near the printer showing the correct loading. In one embodiment of the invention, the correct loading of the paper is “face-up, head-out.” Depending on the make and model of printer used, the orientation may be different.

As can be understood from the foregoing, it can be understood that handheld 150 composes record 300 for printing and causes printer 140 to print 6 sheets for each page. Accordingly, to produce a final manifest (block 260) correctly, each time that handheld 150 prints a page, six sheets are generated. Thus, if there is a paper jam, the print job must be canceled, any printed sheets should be destroyed, sheets should be removed from printer 140 until the numeral 1 of pre-printed numbering 1020 appears on the next sheet to be printed, and the print job should be re-sent. In another embodiment, the manifest paper 1010 has no pre-printed number 1020 or routing instruction 1030, and printer 140 prints such content during a pick-up event. In one embodiment of the invention, printer 140 is capable of printing in color.

Once the manifest has printed correctly, and has been assembled and stapled on the clipboard, the representative signs the paper manifest and electronically signs the manifest record 300 via handheld 150. Acceptance of the e-signature will lock the manifest data, preventing any future edits to record 300. Handheld 150 can transmit the acceptance to waste tracking system 110 or otherwise signal waste tracking system 110 that the manifest number has been used. Handheld 150 can transmit the final record 300, including any edits made in the field, to waste tracking system 110.

In an alternative embodiment of the invention, manifests are printed in an office and a person is dispatched to a pick-up events with a handheld containing an open work order and a manifest record 300 as well as a printed manifest and optionally clipboard 1110. This embodiment may be suitable, for example, where the transporter entity obtains all information about the material to be shipped (block 210) before sending a route to handheld 150 (block 230), and thus will not need to edit line information (block 245) or edit manifest information (block 255). In this embodiment of the invention, a vehicle does not need to be equipped with printing system 500. The manifest is printed in an office. A person working out in the field can take the clipboard, the printed manifest, and handheld 150 to a pick-up event. In this embodiment, the person working out in the field can double-check the accuracy of the printed manifest before obtaining paper and electronic signatures. Acceptance of the electronic signature locks the manifest number and prevents any future edits to manifest record 300.

In yet another embodiment of the invention, a manifest is produced without using handheld 150. According to this embodiment, a person working in an office creates a work order (block 215) and subsequently prints a corresponding manifest. Waste tracking system 110 may be used to generate a manifest number and associate it with each pick-up event. The same or another person may take a printed manifest and a vehicle to a pick-up site, but does not need to take printing system 500 or handheld 150. In this embodiment, a hand-written signature is obtained on the printed manifest, and the corresponding manifest record 300 in waste tracking system 110 is subsequently closed or locked, when information pertaining to the signed manifest is received in the transporter entity's office.

In one embodiment of the invention, a page of each manifest is printed to substantially represent EPA Form 8700-22. Another page of each manifest is printed to substantially represent EPA Form 8700-22A. In one embodiment of the invention, the manifest is produced and handled substantially as described in 40 CFR §262, subpart B, the contents of which are hereby incorporated by reference in their entirety.

In one embodiment of the invention, shipment tracking system 100 comprises a central computer program, a database, and servers. A component of system 100 contains or controls the allocation and distribution of the unique manifest tracking numbers to be printed on each manifest. System 100 allocates a unique set of sequential tracking numbers for tracking shipments. A tracking number may be generated and used internally, to track the progress of material as it shipped among multiple points within a large, multi-facility entity, even in cases where the single entity maintains custody, responsibility, or ownership of the contents of the shipment throughout shipping.

In one embodiment of the invention, a uniquely numbered manifest is produced and used to track a shipment of material from any origin to any destination, with or without any intermediate custodial facility. The origin facility may be a generator, a transfer facility, or a TSDF. Any intermediate custodial facility may be a generator, a transfer facility, or a TSDF. The destination facility may be a generator, a transfer facility, or a TSDF. It can be appreciated that this embodiment of the invention provides a valuable tool for tracking material if it is shipped between TSDFs, for instance, or if a generator ships material to another facility and despite a mistake or misunderstanding, the second facility has the status of generator. Embodiments of this invention can provide valuable tracking tools in the event that materials must be shipped away from a TSDF, for instance, in response to an unexpected emergency.

In embodiments discussed above, where one party is identified as a generator and the party producing the manifest is identified as a transporter, it is meant to be understood that those labels are used for clarity, to allow the embodiment to best illustrate the invention. The methods of the invention include embodiments in which one transporter generates a manifest when obtaining materials from another transporter, or when a TSDF generates a manifest. In one embodiment, the invention supplies methods and systems for producing a manifest and for tracking a shipment, regardless of the specific identities of the parties.

In one embodiment, a manifest is printed onboard a transporter's vehicle and is populated with the unique manifest tracking number along with other required information such as generator, transporter and designated facility identification, phone numbers, and waste descriptions. In one embodiment, the invention provides methods and systems for tracking waste. The waste may comprise hazardous waste, non-hazardous waste, or both.

In one embodiment of the invention, components of the invention are customized for clinical, hospital, or medical waste. The transporter vehicles may have specialized containers, such as a container for biohazards, a container for sharps, a container for pharmaceuticals, and a container for another kind of waste. A database contained in shipment tracking system 100 may supply waste codes useful for the waste, including specialized pharmaceutical waste codes and codes for biologics waste. Containers in the vehicle may be specially designed to correspond to sorting containers found at generator facilities. Containers may be color-coded, for instance by kind of waste, according to a unique color code, an industry-standard color code, or a generator's private color code.

In one embodiment of the invention, printer 140 can print labels as well manifests. Waste can be put into containers, and information about that waste can be put into handheld 150. Handheld 150 can then be made to cause printer 140 to print labels. Printer 140 can be loaded with adhesive label paper. The labels can be affixed to the containers. In an alternative embodiment, the containers can have label pouches on them, and paper labels can be inserted into the pouches.

In one embodiment of the invention, handheld 150 can generate labels for printing automatically and responsive to information entered into record 300.

In one embodiment of the invention, handheld 150 or waste tracking system 110 can perform an operation responsive to entry of specific waste information in waste information field 330. For instance, a component of system 100 can respond to information about a specific type and quantity of waste by issuing an alert notification that the waste: requires special handling; must be refused; changes the legal status of the generator or transporter; requires special billing; requires a special container or labeling; can be mixed with another waste listed; cannot be mixed with another waste listed; can or cannot be incinerated; must or must not be autoclaved; must be inspected for certain properties before pick up; or requires some other consideration. An act to supply information—such as scanning a barcode, keying in information, or choosing a waste code from a menu, and/or entering a quantity—can cause a set of program instructions to run in system 100, for instance, in handheld 150, either substantially immediately or at some other time.

In one embodiment of the invention, communication between waste tracking system 110, or a database contained therein, and handheld 150 is accomplished as a “sync” process. The unique manifest tracking number along with other required information by generator or customer is downloaded at the start of day, and then when the air card (3G and 4G where available) network is available, an update will be sent from the handheld 150 to waste tracking system 110, or a database contained therein. This will record the final disposition of the unique manifest tracking number and the specific client that the unique manifest number was applied to.

If a manifest was successfully created using the allocated unique manifest tracking number but was destroyed or unused, that unique number can be recorded in waste tracking system 110 as no longer available.

Based on the “sync” process, transporter will be able to maintain a high degree of control over the unique manifest tracking numbers to ensure that a number will not be used more than once, according to this embodiment of the invention. This update process can also identify potential printing issues and allow their correction at the earliest practicable time.

In one embodiment of the invention, the system has means to identify or prevent deviations from an intended function or sequence of functions. For instance, there can be secondary means to prevent duplication of manifest numbers. In one embodiment, after a waste is picked up and a manifest is generated, the manifested waste is transported to the transporter's facility. The manifest number can then be read from the printed manifest and entered into waste tracking system 110. Waste tracking system 110 can compare it to the number in manifest number field 310 in record 300. Waste tracking system 110 can be programmed to refuse to allow entry of a duplicate manifest number, thereby providing a secondary means to identify potential printing issues.

In one embodiment, methods and systems of the invention can be used to track shipments primarily by the production of a uniquely numbered electronic manifest. In this embodiment, producing a final manifest (block 260) requires determining that the contents of record 300 accurately describe the material to be shipped. Record 300 is electronically signed or certified, thereby turning it into a final, electronic manifest. In this embodiment of the invention, a paper manifest may still optionally be produced as a duplicate system, to verify the accuracy of electronic files, or to supply a hard-copy backup in the event of network or power outages. In this embodiment of the invention, handheld 150 can provide a copy of the certified electronic manifest, or e-manifest, to each entity designated to receive one. The e-manifest may be a locked or un-editable electronic file such as a PDF or other proprietary format file. According to this embodiment of the invention, the printer 140, the clipboard 1110, and manifest paper 1010, are each optional. A process according to this embodiment of the invention proceeds substantially as illustrated in FIG. 2, and production (block 260) of the final manifest may involves the steps of generating, certifying, and distributing a digital file comprising information from record 300.

Accordingly, methods of the invention can be used to produce an electronic version of the Uniform Hazardous Waste Manifest for subsequent hard copy or electronic distribution to the various participants in the waste disposal process (e.g., generators, transporters, and treatment facilities). A copy of the Uniform Hazardous Waste Manifest, separated into two parts (EPA Form 8700-22 and EPA Form 8700-22A), may be obtained from the EPA web site at the domain “gov”, by searching for EPA Form 8700-22 and EPA Form 8700-22A. The two separate parts of the form are hereby incorporated by reference.

As noted above, the manifest can contain three primary sections: the header section, the body section, and the signature section. The body section may be used to capture waste profile information, specific weight of the waste to be transported, the container type, number of containers, etc. In certain aspects, the electronic manifest of the invention is an exact electronic duplicate of the EPA Uniform Hazardous Waste Manifest in a PDF format. Of course, other electronic formats can be used, including text files, XML files, MS Word files, and JPEG files. The PDF format (as well as others mentioned) allows information to be entered for the header, body, and signature sections using a variety of methods explained in further detail below. To enter the data, methods of the invention may define in extensible markup language (XML), the data feeds needed to fully and legally complete the electronic manifest. This method merges the data and form to create a perfect copy of the manifest with highly legible data on all pages of the form. It may be preferable for the document to contain some text or portions that appear “upside down” with respect to other text or portions. In this way, a manifest document can be uniform with other manifests (e.g., paper-based manifests) that an organization uses. As such, if an organization digitizes a large number of paper manifests by scanning, there will be consistency across an entire repository of electronic manifests that includes originally-paper manifests as well as always-electronic manifests, thereby making automatic optical character recognition, data retrieval, or indexing possible across the repository.

Fields (including signature information) of the provided electronic manifest can be populated in a variety of ways. In one aspect, signature can be entered onto an electronic device, such as a desktop computer, laptop computer, tablet, smartphone, or handheld device, using a stylus device. The signature would be stored electronically on the electronic device and placed in the electronic version of the form for subsequent printing or electronic transmission to the appropriate parties.

In another aspect, the signature is again captured on an electronic device utilizing a stylus device. The signature again would be stored electronically and placed in an electronic version of the form for subsequent printing or electronic transmission to the appropriate parties. In addition, the signatory would provide additional validation of their identity. This can be any additional information outside of a signature that confirms the signatory's identity. For example, the signatory's social security number (or last four digits) may be used. In a preferred embodiment, the additional validation is the signatory's driver's license identification number. The driver's license number can be linked to the signature and also stored electronically. This proof of identity combined with the electronic version of the signature provides strong evidence for the purpose of any litigation that occurs in the event of a spill or leak.

In a further aspect, a combination digital pen/ink pen device is used to obtain the signature. A digital pen is an input device which captures the handwriting or brush strokes of a user, converts handwritten analog information created using “pen and paper” into digital data, enabling the data to be utilized in various applications. For example, the writing data can be digitized and uploaded to a computer and displayed on its monitor. The data can then be interpreted by handwriting software (OCR) and used in different applications or just as graphics. A digital pen is generally larger and has more features than a stylus. Digital pens typically contain internal electronics, and have features such as touch sensitivity, input buttons, memory, writing data transmission capabilities, and electronic erasers.

As encompassed by the invention, the digital pen may be a combination pen with both digital and ink capabilities. Such pens are known in the art. Suitable pens include, for example, the Vidal Triple Function Digital Pen (VIDALBP) by Myron. The combination pen is able to provide a “wet” signature in ink on the top page of the standard printed form, while the electronic aspects of the pen capture an electronic version of the signature as the pen moves during signing. This electronic signature provides an identical match to the original signature and is applied to the subsequent pages of the manifest for printing or electronic distribution to the appropriate parties.

In further aspects of the invention, methods utilizing transporter and treatment facility employee signatures are provided. It is contemplated that employees involved in the waste disposal process have an employee identification number. The method provides the use of an employee signature that will be placed within the form based on entry of an employee number. As an alternative, the personnel number can be used in lieu of the actual signature.

In one embodiment, methods and systems of the invention are used to track the shipment of hazardous materials. In an embodiment of the invention, material may not meet the EPA definition of hazardous waste. A manifest according to the invention may supply a valuable tool for monitoring or tracking a shipment of material.

In one embodiment of the invention, shipment is a process of purposefully moving material. In one embodiment of the invention, system 100 is used to track a shipment which may consist essentially of movement of materials within an organization, for instance, from one storage facility to another. In one embodiment, the invention supplies information about the location, custodial history, or destination of a material.

It will be apparent that aspects, as described above, may be implemented in many different forms of software, firmware, and hardware in the implementations illustrated in the figures. The actual software code or specialized hardware used to implement these aspects is not limiting of the description provided herein. Thus, the operation and behavior of the aspects are described without reference to the specific software code, it being understood that software and hardware can be designed to implement the aspects based on the description herein.

No element, act, or instruction used in the present application should be construed as critical or essential to the present disclosure unless explicitly described as such. In addition, as used herein, the article “a” is intended to include one or more items. Where only one item is intended, explicit language so indicating is used. Unless otherwise indicated, the conjunction “or” is used in the inclusive sense. The phrase “based on” is used to mean “based, at least in part, on” unless explicitly stated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes. Additionally, EPA Form 8700-22 and EPA Form 8700-22A, available from the EPA web site, are also incorporated in their entirety.

### Equivalents

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

What is claimed is:

1. A method of creating a manifest for tracking a shipment, the method comprising:
obtaining information pertinent to an intended shipment;
storing the information in a memory of an electronic device;
creating a work order record containing the information pertinent to the intended shipment and storing the work record in the memory;
storing a manifest number in the work order record;
generating an electronic manifest record comprising the manifest number pertinent to the intended shipment; and
providing a final copy of the manifest, wherein the final copy of the manifest is in an electronic format.

2. The method of claim 1, wherein obtaining information pertinent to an intended shipment comprises obtaining a digital copy of a signature.

3. The method of claim 2, wherein obtaining a digital copy of a signature comprises using a stylus device in conjunction with the electronic device to generate a digital copy of a signature.

4. The method of claim 3, wherein the electronic device is selected from a group consisting of a desktop computer, a laptop computer, a tablet device, a personal digital assistant, a smartphone, and an electronic handheld device.

5. The method of claim 2, wherein obtaining information pertinent to an intended shipment further comprises obtaining a wet signature simultaneously with the digital signature.

6. The method of claim 5, wherein the electronic device comprises a combination digital/ink pen.

7. The method of claim 3, wherein obtaining information pertinent to an intended shipment further comprises obtaining a non-signature confirmation of identity.

8. The method of claim 7, wherein the non-signature confirmation of identity is a driver's license identification number.

9. The method of claim 2, wherein obtaining information pertinent to an intended shipment comprises obtaining an employee identification number.

10. The method of claim 1, wherein the electronic device comprises a processor and a memory, wherein the memory contains instructions that when executed, cause the processor to:
obtain information pertinent to an intended shipment;
store the information in the memory;
create a work order record containing the information pertinent to the intended shipment and storing the work order record in the memory;
store a manifest number in the work order record;
generate an electronic manifest record comprising the manifest number and the information pertinent to the intended shipment; and
provide a final copy of the manifest, wherein the final copy of the manifest is in an electronic format.

11. The method of claim 1, wherein the manifest is a replica of a United States Environmental Protection Agency uniform hazardous waste manifest.

12. The method of claim 1, wherein the manifest comprises a header section, a body section, and a signature section.

13. The method of claim 1, wherein the electronic format is a Personal Document Format file.

14. The method of claim 1, wherein the intended shipment comprises hazardous waste according to the Resource Conservation and Recovery Act.

15. The method of claim 1, wherein the final copy of the manifest comprises text that appears upside-down with respect to other text within the document.

16. The method of claim 1, wherein the electronic device comprises a processor coupled to the memory and the memory comprises a tangible, non-transitory storage medium.
